(19) United States
(12) Patent Application Publication
(10) Pub. No.: US 2025/0163968 A1
(43) Pub. Date: May 22, 2025

(54) JIG FOR ASSISTING ATTACHMENT OF RAIL COVER

(71) Applicant: THK CO., LTD., Tokyo (JP)

(72) Inventors: Katsuya Iida, Tokyo (JP); Soshi Miyahara, Tokyo (JP); Mitsumasa Wada, Tokyo (JP); Masakazu Takahashi, Tokyo (JP); Yuki Nakamura, Tokyo (JP)

(73) Assignee: THK CO., LTD., Tokyo (JP)

(21) Appl. No.: 18/841,555

(22) PCT Filed: Feb. 8, 2023
(86) PCT No.: PCT/JP2023/004135

§ 371 Date: Aug. 26, 2024

(30) Foreign Application Priority Data
Mar. 30, 2022 (JP) 2022-055304

(51) Int. Cl. F16C 43/04

(52) U.S. Cl. CPC F16C 43/04

(57) ABSTRACT

An attachment assisting jig for a rail cover enables easily mounting of the rail cover configured to cover an upper surface of a track rail without removing a moving block from the track rail of a motion guide device. The rail cover includes: a flat surface portion configured to cover the upper surface of the track rail; and a pair of side wall portions, which are provided at both ends of the flat surface portion in a short-side direction thereof, respectively. The attachment assisting jig includes: a jig main body configured to be pushed and pulled in a longitudinal direction of the rail cover; and a pair of pressing rollers, which are arranged on a bottom surface of the jig main body so that peripheral surfaces of the pair of pressing rollers are brought into abutment against inner side surfaces of the pair of side wall portions (250), respectively.

### TECHNICAL FIELD

The present invention relates to an attachment assisting jig for a rail cover, which is used at the time of spreading side wall portions of a rail cover that covers an upper surface of a track rail in a motion guide device.

### BACKGROUND ART

A motion guide device is used for a linear guide portion or a curved guide portion of various kinds of machine tools and conveying devices in many cases. The motion guide device includes a track rail and a moving block. In the track rail, a rolling surface for balls is formed along a longitudinal direction. The moving block is assembled to the track rail through intermediation of balls that roll on the rolling surface. Further, the moving block has an endless circulation path for the balls, and when the balls circulate in such an endless circulation path, the moving block is capable of continuously moving in the longitudinal direction of the track rail.

With regard to the use of the motion guide device, it is common to mount a pair of seal members to both ends of the moving block in a moving direction thereof. The seal members are in close contact with the track rail, and hence a gap between the moving block and the track rail is hermetically sealed, to thereby prevent foreign matter, such as shavings of a workpiece or dust which adhere to the track rail, from entering the inside of the moving block.

Meanwhile, a bolt mounting hole is formed in the track rail so as to be used at the time of laying the track rail on a mechanical device or the like. Thus, even when the seal member is attached to the moving block, the foreign matter may enter the inside of the moving block via a rail mounting hole. In addition, there has been also a concern in that the seal member rubs against an opening edge of the bolt mounting hole, with the result that the seal member wears down early or is damaged early.

In view of the above, in such a motion guide device, a rail cover to be attached to the track rail is prepared, and there is disclosed a jig used at the time of attachment of the rail cover in Patent Literature 1. The rail cover is formed from an elongated plate member made of a metal, and includes a flat surface portion and a pair of side wall portions. The flat surface portion is configured to cover an upper surface of the track rail. The pair of side wall portions are provided at both ends in a short-side direction of the flat surface portion, respectively. The rail cover is attached to the track rail along the longitudinal direction of the track rail, and is configured to cover the bolt mounting hole formed on the track rail. The rail cover is mounted to the track rail using, for example, the jig disclosed in Patent Literature 1 under a state in which the moving block is removed from the track rail. When the rail cover is sequentially pressed by the jig along the longitudinal direction of the track rail, the pair of side wall portions are forcibly spread. Thus, the rail cover is attached to the track rail.

### CITATION LIST

### Patent Literature

[PTL 1] JP 2019-002561 A

### DISCLOSURE OF THE INVENTION

### Problems to be Solved by Invention

However, when the rail cover is mounted to the track rail after removing the moving block, there arises a need to mount the moving block to the track rail again after mounting the rail cover to the track rail. Thus, in a related-art method of mounting the rail cover, it has been cumbersome because there arises the need for removal and re-mounting of the moving block. Further, there has been also a concern in that a flaw or a defect is caused in the motion guide device due to the removal and re-mounting of the moving block.

### MEANS FOR SOLVING THE PROBLEMS

The present invention has been made in view of the above-mentioned problems, and has an object to provide an attachment assisting jig for a rail cover, which is capable of easily attaching the rail cover without removing a moving block from a track rail of a motion guide device.

That is, according to the present invention, there is provided an attachment assisting jig for a rail cover, which is to be used at the time of attaching a rail cover covering an upper surface of a track rail to the track rail of a motion guide device. The rail cover includes: a flat surface portion configured to cover the upper surface of the track rail; and a pair of side wall portions, which are provided at both ends of the flat surface portion in a short-side direction thereof, respectively, and are configured to elastically hold side surfaces of the track rail, respectively. The assisting jig is to be used at the time of adjusting a distance between the pair of side wall portions. The assisting jig includes: a jig main body, which has an operating grip on an upper surface thereof, and is configured to be pushed and pulled in a longitudinal direction of the rail cover; and a pair of pressing rollers, which are arranged on a bottom surface of the jig main body so that peripheral surfaces of the pair of pressing rollers are brought into abutment against inner side surfaces of the pair of side wall portions, respectively, and are rotated in directions opposite to each other, and are configured to press the pair of side wall portions outward along with movement of the jig main body in the longitudinal direction of the rail cover.

### EFFECTS OF THE INVENTION

According to the attachment assisting jig of the present invention, when the attachment assisting jig is pushed and pulled in the longitudinal direction of the rail cover which is before being attached to the track rail, the pair of pressing rollers press the pair of side wall portions outward, and thus, the distance between the pair of side wall portions opposed to each other can be easily widened. Accordingly, when the rail cover is attached to the track rail, an elastic holding force with which the pair of side wall portions apply to side surfaces of the track rail becomes weaker, and as a result, it becomes possible to slide the rail cover to insert the rail cover into a gap between the track rail and the moving block. Thus, when the attachment assisting jig of the present invention is used with respect to the rail cover, there is no need to remove the moving block from the track rail at the time of mounting the rail cover to the track rail, and hence the cumbersomeness accompanied with the mounting of the rail cover can be eliminated. Further, a trouble that causes a flaw or a defect can be prevented at the time when the moving block is removed from and re-mounted to the track rail. In addition, the side wall portions of the rail cover are not excessively spread, and hence the rail cover attached to the track rail is prevented from interfering with the moving block moving on the track rail, and thus, the function of the moving block is not impaired.

### BRIEF DESCRIPTION OF DRAWINGS

FIG. 1 is a perspective view for illustrating one example of a motion guide device.

FIG. 2 is a sectional view for illustrating a state before a rail cover is attached to a track rail of the motion guide device.

FIG. 3 is a perspective view for illustrating a first embodiment of an attachment assisting jig for a rail cover to which the present invention is applied.

FIG. 4 is a bottom view of the attachment assisting jig for a rail cover according to the first embodiment.

FIG. 5 is an explanatory schematic view for illustrating a guide member and a mechanism for adjusting a distance between a pair of pressing rollers.

FIG. 6 is a perspective view for illustrating a second embodiment of an attachment assisting jig for a rail cover to which the present invention is applied.

FIG. 7 is a bottom view of the attachment assisting jig for a rail cover according to the second embodiment.

FIG. 8 is an explanatory schematic view for illustrating a third embodiment of an attachment assisting jig for a rail cover to which the present invention is applied.

FIG. 9 is a schematic view for illustrating a method for use of the attachment assisting jig for a rail cover according to the third embodiment.

### MODE FOR CARRYING OUT THE INVENTION

Now, an attachment assisting jig for a rail cover to which the present invention is applied is described in detail with reference to the attached drawings.

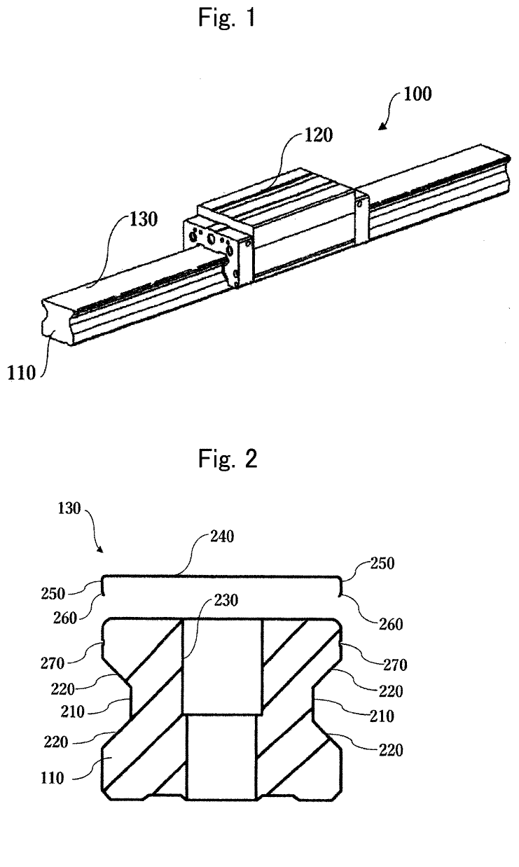

FIG. 1 is a perspective view for illustrating a motion guide device 100. The motion guide device 100 is used in various kinds of machine tools, conveying devices, and the like. The motion guide device 100 includes a track rail 110, a moving block 120, and a rail cover 130. The track rail 110 is formed in a linear shape. The moving block 120 is assembled to the track rail 110 through intermediation of a large number of rolling elements. The rail cover 130 covers an upper surface of the track rail 110. The moving block 120 has an endless circulation path for the large number of rolling elements, and when the rolling elements roll on rolling surfaces formed in the track rail 110, the moving block 120 can freely reciprocate in a longitudinal direction of the track rail 110.

FIG. 2 is a sectional view of the track rail 110 and the rail cover 130, which is taken along a direction orthogonal to the longitudinal direction of the track rail 110 and the rail cover 130, and shows a state in which the track rail 110 and the rail cover 130 are separated from each other. The track rail 110 is formed in a substantially rectangular shape in cross section, and groove portions 210 are formed along the longitudinal direction in both side surfaces of the track rail 110, respectively. On an upper side and a lower side of each of the groove portions 210, there are formed rolling surfaces 220 for allowing rollers serving as the rolling elements to roll thereon. Further, a plurality of bolt mounting holes 230 are formed in the track rail 110 at predetermined intervals in the longitudinal direction. Those bolt mounting holes 230 are used at the time of laying the track rail 110 on a fixed portion such as a mechanical device with use of fixing bolts. In FIG. 1, those plurality of bolt mounting holes 230 are covered with the rail cover 130, to thereby prevent foreign matter such as shavings of a workpiece or dust from entering the bolt mounting holes 230.

The rail cover 130 is formed from a plate-shaped member made of stainless steel, and includes a flat surface portion 240 and a pair of side wall portions 250. The flat surface portion 240 is formed in an elongated shape. The pair of side wall portions 250 are provided at both ends of the flat surface portion 240 in a short-side direction thereof. The pair of side wall portions 250 are bent in a substantially vertical manner with respect to the flat surface portion 240 to stand upright, and are provided in a continuous manner in a longitudinal direction of the rail cover 130.

At distal ends of the pair of side wall portions 250, a pair of locking portions 260 are provided. The pair of locking portions 260 are formed by being slightly bent with respect to an inner side of the rail cover 130. Thus, when the rail cover 130 is attached to the track rail 110, the track rail 110 is required to be pushed in between those locking portions 260 such that the pair of locking portions 260 are spread outward. Meanwhile, on both side surfaces in the vicinity of upper corner portions of the track rail 110, a pair of cover fixing grooves 270 corresponding to the pair of locking portions 260 are formed. Accordingly, when the rail cover 130 is completely attached to the track rail 110, the pair of locking portions 260 enter the pair of cover fixing grooves 270, and hence the pair of locking portions 260 elastically hold the track rail 110. Thus, the rail cover 130 is firmly fixed to the track rail 110.

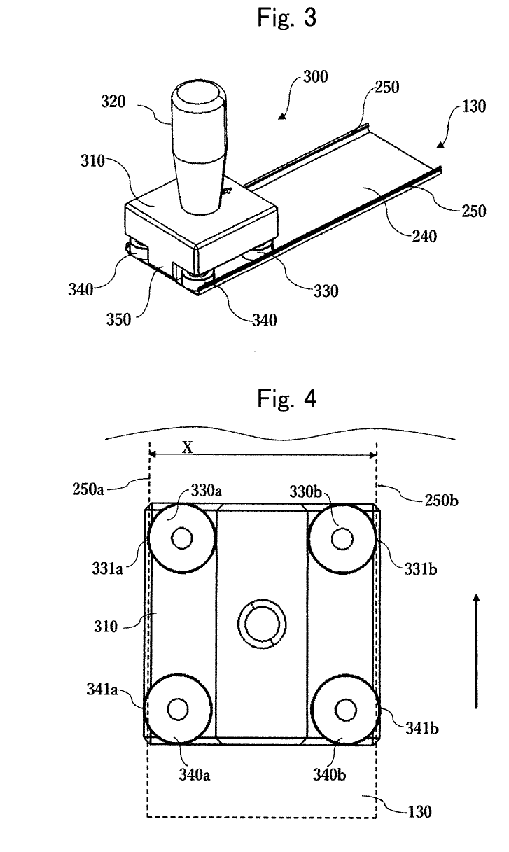

FIG. 3 is a perspective view for illustrating a first embodiment of an attachment assisting jig 300 for a rail cover to which the present invention is applied.

The attachment assisting jig 300 is used at the time of adjusting a distance between the pair of side wall portions 250 of the rail cover 130, and the pair of side wall portions 250 of the rail cover 130 can be spread outward. The attachment assisting jig 300 incudes a jig main body 310, an operating grip 320, a guide member 330, a pair of pressing rollers 340, and a pressing member 350. The jig main body 310 is configured to be pushed and pulled in the longitudinal direction of the rail cover 130. The operating grip 320 is provided on an upper surface of the jig main body 310. The guide member 330 is formed of a pair of guide rollers. The pressing member 350 is provided on a bottom surface of the jig main body 310.

The pair of guide rollers 330 are provided on the bottom surface of the jig main body 310. The pair of guide rollers 330 are provided so that support shafts thereof are orthogonal to the jig main body 310. The pair of guide rollers 330 are arranged with a certain distance in a short-side direction of the rail cover 130. When the attachment assisting jig 300 is used with respect to the rail cover 130, the pair of guide rollers 330 play a role in guiding the jig main body 310 in the longitudinal direction of the rail cover 130. The guide member 330 is not always required to be formed of a pair of guide rollers, and design such as its shape or arrangement can be appropriately changed as long as the guide member 330 can stably guide the jig main body 310 in the longitudinal direction of the rail cover 130. Further, the guide member is provided in consideration of ease of use of the attachment assisting jig, and the guide member is not an essential component of the present invention.

The pair of pressing rollers 340 are provided on the bottom surface of the jig main body 310. Each of the pressing rollers 340 is provided so that a support shaft thereof is orthogonal to the jig main body 310. The pair of pressing rollers 340 are arranged with a certain distance in the short-side direction of the rail cover 130. When the attachment assisting jig 300 is used with respect to the rail cover 130, the pair of pressing rollers 340 play a role in pressing the pair of side wall portions 250 outward.

The pressing member 350 is provided so as to protrude downward from the bottom surface of the jig main body 310. The pressing member 350 is provided so as to be brought into abutment against the flat surface portion 240 of the rail cover 130. In this embodiment, the pressing member 350 is provided so as to be interposed between the pair of guide rollers 330 and between the pair of pressing rollers 340. The pressing member 350 may be a replaceable-type pressing member, which enables each of pressing members having different sizes to be attached. In this embodiment, the pressing member 350 is provided to the attachment assisting jig 300. However, the pressing member 350 is not always required to be provided.

FIG. 4 is a bottom view of the attachment assisting jig 300. The broken line in the figure indicates a portion of the rail cover 130. In FIG. 4 which shows the bottom surface of the jig main body 310, two rollers provided on an upper side of the drawing sheet are the pair of guide rollers 330. When the attachment assisting jig 300 is placed on the rail cover 130, a guide roller 330a is brought into abutment against an inner side surface of a side wall portion 250a on a left side of the drawing sheet, and a guide roller 330b is brought into abutment against an inner side surface of a side wall portion 250b on a right side of the drawing sheet. That is, peripheral surfaces of the pair of guide rollers 330 are brought into abutment against the inner side surfaces of the pair of side wall portions 250 so as to correspond thereto, respectively. In this embodiment, although the guide member 330 is formed as the pair of guide rollers 330, and the pair of guide rollers 330 are in abutment against the inner side surfaces of the pair of side wall portions 250, respectively, it is only required that a side surface of the guide member 330 be provided so as to be brought into abutment against at least any one of the inner side surfaces of the pair of side wall portions 250. Portions in which the pair of guide rollers 330 are brought into abutment against the pair of side wall portions 250 are hereinafter referred to as “pair of first abutment portions 331.”

As illustrated in FIG. 4, a distance between a first abutment portion 331a in which the guide roller 330a and the side wall portion 250a are brought into abutment against each other and a first abutment portion 331b in which the guide roller 330b and the side wall portion 250b are brought into abutment against each other is substantially the same in length as a distance X between the inner side surfaces of the pair of side wall portions 250 opposed to each other. In other words, the sum of a distance between a support shaft of the guide roller 330a and a support shaft of the guide roller 330b, and a diameter of the guide roller 330 are substantially the same as the distance X.

In FIG. 4 which shows the bottom surface of the jig main body 310, two rollers provided on a lower side of the drawing sheet are the pair of pressing rollers 340. When the attachment assisting jig 300 is placed on the rail cover 130, a pressing roller 340a is brought into abutment against the inner side surface of the side wall portion 250a on the left side of the drawing sheet, and a pressing roller 340b is brought into abutment against an inner side surface of a side wall portion 250b on the right side of the drawing sheet. That is, peripheral surfaces of the pressing rollers 340 are brought into abutment against the inner side surfaces of the pair of side wall portions 250 so as to correspond thereto, respectively. Portions in which the pair of pressing rollers 340 are brought into abutment against the pair of side wall portions 250 are hereinafter referred to as “pair of second abutment portions 341.”

A distance between a second abutment portion 341a in which the pressing roller 340a and the side wall portion 250a are brought into abutment against each other and a second abutment portion 341b in which the pressing roller 340b and the side wall portion 250b are brought into abutment against each other is set slightly larger than the distance X. In other words, the sum of a distance between a support shaft of the pressing roller 340a and a support shaft of the pressing roller 340b, and a diameter of the pressing roller 340 is set slightly larger than the distance X. When compared with an arrangement distance between the pair of guide rollers 330, an arrangement distance between the pair of pressing rollers 340 is set larger than the arrangement distance between the pair of guide rollers 330. Thus, the pair of pressing rollers 340 are arranged on the bottom surface of the jig main body 310 so that, when the pair of pressing rollers 340 are inserted into a space between the pair of side wall portions 250, and the jig main body 310 is caused to slide in the longitudinal direction of the rail cover 130, the peripheral surfaces of the pair of pressing rollers 340 are brought into abutment against the inner side surfaces of the pair of side wall portions 250, respectively, and are rotated in directions opposite to each other.

Next, description is given of one example of a method of attaching the rail cover 130 to the track rail 110 with use of the attachment assisting jig 300.

First, prior to the attachment of the rail cover, a pre-process for the rail cover 130 is performed using the attachment assisting jig. In the pre-process, the attachment assisting jig 300 is inserted into the space between the pair of side wall portions 250 from one end portion of the rail cover 130, and is forcibly moved in the longitudinal direction of the rail cover 130.

When the attachment assisting jig 300 is inserted into the space between the pair of side wall portions 250, the attachment assisting jig 300 is pushed forward while the pair of guide rollers 330 are located at the front. As described above, the pair of guide rollers 330 are arranged so as to correspond to the distance X between the inner side surfaces of the pair of side wall portions 250, and thus, when the attachment assisting jig is pushed forward, the guide rollers 330 rotate in directions opposite to each other while being in abutment against the side wall portions 250 of the rail cover 130, respectively, thereby being capable of easily introducing the attachment assisting jig into the space between the pair of side wall portions.

When the attachment assisting jig 300 is further pushed forward, the pair of pressing rollers 340 enter the space between the pair of side wall portions 250. The distance between the pair of pressing rollers 340 is set so that a distance between the second abutment portions 341 is slightly larger than the distance X. Thus, at the time of entering the space between the pair of side wall portions 250, those pair of pressing rollers 340 enter the space while forcibly spreading the side wall portions 250 outward in a width direction of the rail cover 130. Further, the pair of pressing rollers 340 are strongly brought into abutment against the pair of side wall portions 250, and thus, when the attachment assisting jig 300 is pushed forward in the longitudinal direction of the rail cover 130, although resistance acts against the force of pushing the operating grip 320 forward, the pressing rollers 340 are brought into abutment against the side wall portions 250 while rotating. As a result, the attachment assisting jig 300 can be smoothly pushed forward. In addition, when the pair of pressing rollers 340 are caused to forcibly enter the space between the pair of side wall portions 250, the guide rollers 330 have been already in a state of being in abutment against the side wall portions 250, and thus, a posture of the attachment assisting jig 300 with respect to the rail cover 130 can be stabilized. Also in this respect, the attachment assisting jig 300 can be easily pushed forward with respect to the rail cover 130.

As described above, when the attachment assisting jig 300 which has been introduced into the space between the pair of side wall portions 250 of the rail cover 130 is pushed forward in the longitudinal direction of the rail cover 130, in a range through which the pair of pressing rollers 340 have passed, the pair of side wall portions 250 are pressed outward in the width direction of the rail cover 130, and hence the side wall portions 250 are plastically deformed with respect to the flat surface portion 240 of the rail cover 130. As a result, the distance between the pair of side wall portions 250 becomes larger compared to the distance before the passage of the pressing rollers 340.

Further, when the pair of side wall portions 250 are pressed outward in the width direction of the rail cover, such a phenomenon occurs that the center of the flat surface portion 240 protrudes in a direction toward the attachment assisting jig 300 due to the rigidity of the rail cover 130. In this respect, in this embodiment, the pressing member 350 is provided to the bottom surface of the jig main body 310, and the pressing member 350 is brought into abutment against the flat surface portion 240 of the rail cover 130. Thus, the pair of side wall portions 250 can be spread outward in the width direction of the rail cover 130 while preventing occurrence of the phenomenon.

The attachment assisting jig 300 is removed from the rail cover 130 after causing the attachment assisting jig 300 to slide by an amount corresponding to a length substantially the same as a length of the moving block 120 on the track rail 110, rather than causing the attachment assisting jig 300 to slide with respect to an entire range in the longitudinal direction of the rail cover 130. With regard to the rail cover 130 obtained after removal of the attachment assisting jig 300, in a range in which the pair of pressing rollers 340 have been moved, a distance between the pair of side wall portions 250 opposed to each other is larger than the distance X before the process performed by the attachment assisting jig 300. Thus, in a movement range of the pair of pressing rollers 340, when the rail cover 130 is attached to the track rail 110, the force with which the locking portion 260 at the distal end of each of the side wall portions 250 enters the cover fixing groove 270 formed on the side surface of the track rail 110 is weak.

Next, the rail cover 130 subjected to the pre-process using the attachment assisting jig 300 as described above is attached to the track rail 110. At the time of attachment, the moving block 120 is moved to one end of the track rail 110, and the attachment of the rail cover is performed under a state in which the moving block is present on the track rail. First, one end in the longitudinal direction of the rail cover 130 with the attachment assisting jig 300 being applied thereto is pressed against the track rail 110 from above, and a part of the rail cover 130 in which the pair of side wall portions 250 have been spread by the pressing rollers 340 is sequentially attached to the track rail 110. The pair of side wall portions 250 are plastically deformed by the attachment assisting jig 300, and hence a distance between the pair of locking portions 260 provided at the distal ends of those side wall portions 250 is widened, and thus, even when the rail cover 130 is pressed against the track rail 110 from above, the pair of locking portions 260 can be fitted to the cover fixing grooves 270 formed in the track rail 110 with a small force. With regard to a part subjected to the pre-process by the attachment assisting jig 300, the rail cover 130 can be easily attached to the track rail 110.

In this case, a degree to which the pair of side wall portions are plastically deformed is determined by the arrangement distance between the pair of pressing rollers with respect to the jig main body. The pair of side wall portions may be plastically deformed to such a degree that the locking portions 260 are loosely fitted to the cover fixing grooves 270, or the pair of side wall portions 250 may be plastically deformed to such a degree that the locking portions 260 do not enter the cover fixing grooves 270. In the former case, a sense of small resistance is caused when an end portion of the rail cover 130 in the longitudinal direction thereof is attached to the track rail 110 from above. On the other hand, in the latter case, the end portion of the rail cover 130 in the longitudinal direction thereof can be attached to the track rail 110 without any sense of resistance.

After a part of the rail cover 130 having been subjected to the pre-process is attached to the track rail 110, the rail cover 130 is caused to slide in the longitudinal direction of the track rail 110 while maintaining the attachment state as it is, and the part of the rail cover 130 having been attached to the track rail 110 is inserted into the moving block 120 on a lower side thereof. The part of the rail cover 130 having already been attached to the track rail 110 is a part in which the pair of side wall portions 250 have been spread by the attachment assisting jig 300, and the locking portions 260 at the distal ends of the side wall portions 250 are loosely fitted to the cover fixing grooves 270 of the track rail, and thus, the part can be caused to easily slide in the longitudinal direction of the track rail 110.

When the end portion of the rail cover 130 that has crawled into the moving block 120 on the lower side thereof reaches the one end of the track rail 110 in the longitudinal direction thereof, the sliding of the rail cover 130 with respect to the track rail 110 is stopped. A range of the rail cover 130 having been subjected to the pre-process by the attachment assisting jig 300 corresponds to the length of the moving block 120 on the track rail 110, and thus, under this state, all the parts of the rail cover 130, which crawl into the moving block 120 on the lower side thereof, are in a state of being attached to the track rail 110.

After that, a part of the rail cover 130 which is not attached to the track rail 110 yet, that is, a part which is not subjected to the pre-process by the attachment assisting jig 300, is pressed against the track rail 110 from above, and is attached to the track rail 110. In the part of the rail cover 130 which is not subjected to the pre-process by the attachment assisting jig 300, the pair of side wall portions 250 are not spread, and as a result, at the time of attaching the rail cover 130, the rail cover 130 is required to be pressed against the track rail 110 from above with a large force. Meanwhile, the part is fitted such that the locking portion 260 provided at the distal end of each of the side wall portions 250 is pushed in the cover fixing groove 270 of the track rail 110 with a large force, and thus, after the part is attached to the track rail 110, it becomes impossible to slide the rail cover 130 in the longitudinal direction of the track rail 110.

As described above, when the rail cover 130 is subjected to the pre-process using the attachment assisting jig 300, at the time of mounting the rail cover 130 to the track rail 110, the attachment of the rail cover 130 can be completed without removing the moving block 120. Thus, when the attachment assisting jig 300 is used, the cumbersomeness accompanied with the mounting of the rail cover 130 to the track rail 110 can be eliminated. Further, it is not required to remove the moving block 120 from the track rail 110, and as a result, it is possible to avoid a flaw or a defect in the motion guide device due to the moving block 120 being re-mounted.

Further, the rail cover 130 is produced by bending a plate-shaped member made of stainless steel, and thus, due to the work hardening at the time of the bending work, the pair of side wall portions 250 are firmly provided upright with respect to the flat surface portion 240. Accordingly, although it is not easy to spread the pair of side wall portions 250, when the attachment assisting jig 300 is used, the rail cover 130 is introduced into the space between the pair of side wall portions 250 while rotating the pair of pressing rollers 340, and those pair of side wall portions 250 can be easily spread outward. Further, the pair of guide rollers 330 serving as the guide member stabilize the posture of the attachment assisting jig 300 with respect to the rail cover 130. Thus, also in this respect, the pre-process for the rail cover 130 prior to the attachment to the track rail 110 can be easily performed.

In addition, when the attachment assisting jig 300 is used, the amount by which the side wall portions of the rail cover are spread outward can be optimized, and thus, an operation error such as a case in which the side wall portions are excessively spread can be prevented. Thus, a trouble such that the rail cover attached to the track rail interferes with the moving block moving on the track rail can be prevented, and hence smooth movement of the moving block on the track rail can be ensured.

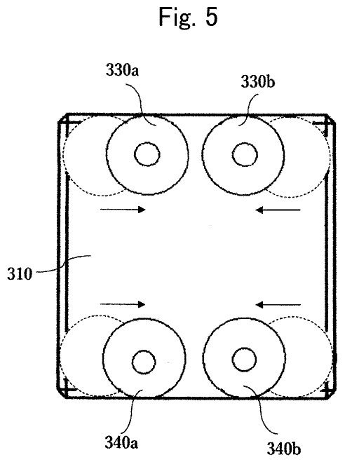

The attachment assisting jig 300 may have an adjustment fixing mechanism (not shown). The adjustment fixing mechanism is capable of suitably changing the arrangement distance between the pair of guide rollers 330 and the arrangement distance between the pair of pressing rollers 340 with respect to the short-side direction of the rail cover 130. Accordingly, the attachment assisting jig 300 can adjust the distance between the abutment portions 331 of the pair of first abutment portions 331 and the distance between the abutment portions 341 of the pair of second abutment portions 341 in accordance with the distance X of the rail cover 130, and thus, the attachment assisting jig 300 can be applied to rail covers 130 of various sizes. For example, when the attachment assisting jig 300 is used with respect to a rail cover having a narrow width, as illustrated in FIG. 5, it is suitable that the pressing member 350 provided on the bottom surface of the jig main body 310 be removed, and the pair of guide rollers 330 and the pair of pressing rollers 340 be fixed after being caused to slide in the vicinity of the center of the jig main body 310. In this case, the pair of guide rollers 330 and the pair of pressing rollers 340 function as the pressing member 350.

Further, in the embodiment described above, although the pair of guide rollers 330 are provided to the jig main body 310, the guide rollers 330 are not always required to be provided, and only the pressing rollers 340 that press the side wall portions 250 of the rail cover 130 may be provided to the jig main body 310.

In addition, in the embodiment described above, although only one pair of pressing rollers 340 are provided to the jig main body 310, a plurality of pairs of pressing rollers 340 may be arranged. In this case, from the viewpoint of gradually plastically deforming the side wall portions 250 of the rail cover 130, an arrangement distance between the pair of pressing rollers may be slightly different in each of the pairs.

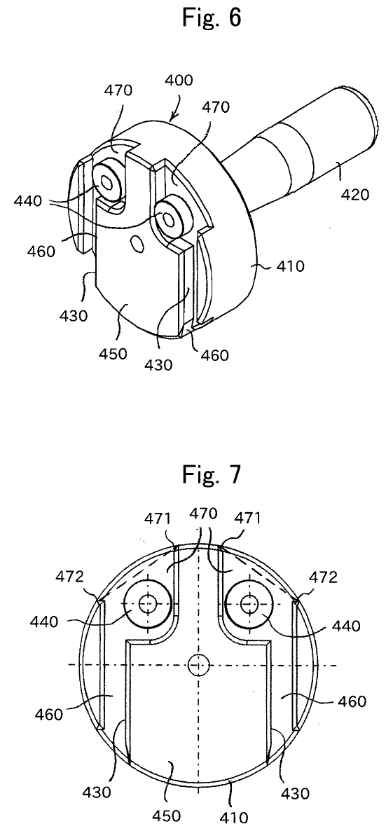

FIG. 6 and FIG. 7 show a second embodiment of an attachment assisting jig for a rail cover to which the present invention is applied.

Similarly to the attachment assisting jig of the first embodiment described above, an attachment assisting jig 400 includes a jig main body 410, an operating grip 420, guide members 430, a pair of pressing rollers 440, and a pressing member 450. The jig main body 410 is configured to be pushed and pulled in the longitudinal direction of the rail cover 130. The operating grip 420 is provided on an upper surface of the jig main body 410. The guide members 430 are brought into abutment against the pair of side wall portions 250 of the rail cover 130 so that a posture of the jig main body 410 with respect to the rail cover 130 is stabilized. The pair of pressing rollers 440 are configured to press the pair of side wall portions 250 from an inner side. The pressing member 450 is provided on a bottom surface of the jig main body 410.

Unlike the attachment assisting jig 300 of the first embodiment illustrated in FIG. 3 being formed in the substantially rectangular shape, the jig main body 410 is formed in a disc shape. In the bottom surface of the jig main body 410, a pair of guide grooves 460 are formed as two grooves parallel with each other with the center of the jig main body 410 located therebetween. The pair of guide grooves 460 correspond to the pair of side wall portions 250 of the rail cover 130. Under a state in which the side wall portions 250 of the rail cover 130 have been introduced into the guide grooves 460, and the pressing member 450 has been in abutment against the flat surface portion 240 of the rail cover 130, the attachment assisting jig 400 is used so as to be pushed and pulled in the longitudinal direction of the rail cover 130.

In this embodiment, one side surface of the pressing member 450 facing the guide groove 460 functions as the guide member 430, and when the side wall portions 250 of the rail cover 130 are introduced into the guide grooves 460, the side wall portions 250 are brought into slide contact with the guide members 430, to thereby achieve stabilization of the posture of the jig main body 410 with respect to the rail cover 130.

Further, on the bottom surface of the jig main body 410, accommodating portions 470 for the pair of pressing rollers 440 are provided. Those accommodating portions 470 are provided in one ends of the guide grooves 460 in a longitudinal direction thereof, respectively, and the pressing rollers 440 are arranged in the accommodating portions 470, respectively. The pressing roller is arranged in the accommodating portion at a position in which an outer peripheral surface of the pressing roller slightly interferes with the side wall portion 250 of the rail cover 130 introduced into the guide groove 460. Thus, when the rail cover is introduced into the guide grooves 460, the pressing rollers 440 are brought into abutment against the side wall portions 250 of the rail cover 130 from the inner side, and press the side wall portions 250 outward in the width direction of the rail cover 130 at the time when the attachment assisting jig 400 is moved in the longitudinal direction of the rail cover 130. Each of the pressing rollers 440 is arranged so that its peripheral surface does not protrude outward from an outer peripheral surface of the jig main body 410.

Further, as illustrated in FIG. 7, the outer peripheral surface of each of the pressing rollers 440 is arranged so as to be closer to the center of the jig main body 410 than a line connecting between opening ends 471 and 472 (indicated by the broken lines in FIG. 7) of each of the accommodating portions 470 with respect to the outer peripheral surface of the jig main body 410, that is, a chord formed by each of the accommodating portions 470 with respect to the outer peripheral surface of the jig main body 410.

The attachment assisting jig 400 of the second embodiment is also used in the same manner as in the attachment assisting jig 300 of the first embodiment. That is, prior to the attachment of the rail cover 130 to the track rail 110, the attachment assisting jig 400 is inserted into the space between the pair of side wall portions 250 from the one end portion of the rail cover 130 and is forcibly moved in the longitudinal direction of the rail cover 130. At that time, the side wall portions 250 are introduced into the guide grooves 460 of the jig main body 410 and are brought into abutment against the pressing rollers 440 after passing through the guide grooves 460.

Further, with the use of the attachment assisting jig 400, in a region in which the attachment assisting jig 400 has been moved with respect to the rail cover 130, that is, a region in which the pressing rollers 440 have been moved with respect to the side wall portions 250 of the rail cover 130, a distance between the pair of side wall portions 250 opposed to each other of the rail cover 130 is slightly larger than that before the process by the attachment assisting jig 400. As a result, even when the rail cover 130 is pressed against the track rail 110 from above, with regard to the part subjected to the pre-process by the attachment assisting jig 300, the rail cover 130 can be easily attached to the track rail 110.

Further, in the attachment assisting jig 400 of the second embodiment, the jig main body 410 is formed in the disc shape without a corner portion, and thus, when the attachment operation for the rail cover 130 with respect to the track rail 110 is performed using the attachment assisting jig 400, it is possible to prevent such a case that the jig main body 410 is unintentionally brought into contact with the rail cover 130, with the result that the rail cover 130 is dented. Further, the outer peripheral surfaces of the pressing rollers 440 are located closer to the center of the jig main body 410 than the chords formed by the accommodating portions 470 with respect to the outer peripheral surface of the jig main body 410. Thus, even when the jig main body 410 is unintentionally dropped on a floor or the like, the pressing roller 440 can be prevented from being brought into contact with a floor or the like, to thereby prevent the pressing roller 440 from being damaged.

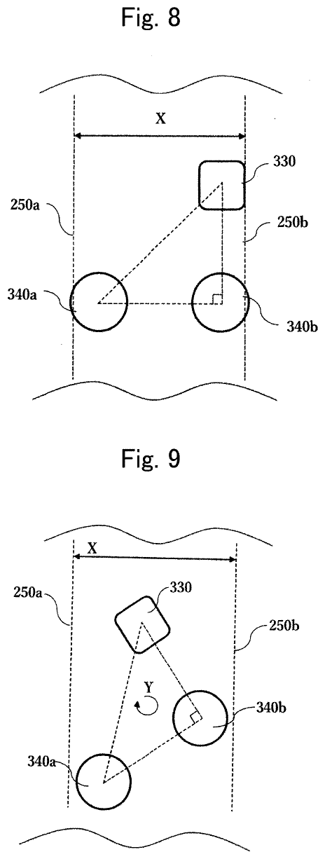

FIG. 8 shows a third embodiment of an attachment assisting jig to which the present invention is applied, and shows a modification example with regard to the arrangement of the guide member 330 and the pressing rollers 340 on the bottom surface of the jig main body 310 of the first embodiment.

In the attachment assisting jig of the third embodiment, the guide member 330 is formed of one member that is brought into slide contact with an inner side of one of the pair of side wall portions 250a and 250b of the rail cover 130. In an example illustrated in FIG. 8, the guide member 330 is arranged on the bottom surface of the jig main body so as to be brought into abutment against the inner side surface of the side wall portion 250b. The pair of pressing rollers 340a and 340b are the same as those of the attachment assisting jig in the first embodiment.

In this case, with respect to a straight line connecting between an axis of the pressing roller 340a and an axis of the pressing roller 340b, a straight line connecting between the center of the guide member 330 and the axis of the pressing roller 340b crosses perpendicularly. Accordingly, when the attachment assisting jig 300 is inclined as illustrated in FIG. 9, the jig main body 310 can be placed on the flat surface portion 240 of the rail cover 130 while the guide member 330 and the pair of pressing rollers 340a and 340b are prevented from interfering with the side wall portions of the rail cover 130. When the attachment assisting jig 300 is rotated from the state illustrated in FIG. 9 in the direction indicated by the arrow Y in the figure, the guide member 330 and the pair of pressing rollers 340a and 340b can be brought into abutment against the side wall portions 250 of the rail cover 130 from the inner side as illustrated in FIG. 8. That is, the attachment assisting jig 300 can be used not from the end portion of the rail cover 130 but even from the vicinity of the center of the rail cover 130.

1. An attachment assisting jig for a rail cover, which is to be used at the time of attaching a rail cover configured to cover an upper surface of a track rail to the track rail of a motion guide device,
wherein the rail cover includes:
a flat surface portion configured to cover the upper surface of the track rail, and
a pair of side wall portions, which are provided at both ends of the flat surface portion in a short-side direction thereof, respectively, and are configured to elastically hold side surfaces of the track rail, respectively,
wherein the assisting jig is to be used at the time of adjusting a distance between the pair of side wall portions, and
wherein the assisting jig comprises:
a jig main body, which includes an operating grip on an upper surface thereof, and is configured to be pushed and pulled in a longitudinal direction of the rail cover; and
at least a pair of pressing rollers, which are arranged on a bottom surface of the jig main body so that peripheral surfaces of the pair of pressing rollers are brought into abutment against inner side surfaces of the pair of side wall portions, respectively, and are rotated in directions opposite to each other, and are configured to press the pair of side wall portions outward along with movement of the jig main body in the longitudinal direction of the rail cover.

2. The attachment assisting jig for a rail cover according to claim 1, further comprising a guide member provided on the bottom surface of the jig main body so that a side surface of the guide member is brought into abutment against at least any one of the inner side surfaces of the pair of side wall portions.

3. The attachment assisting jig for a rail cover according to claim 1, wherein the jig main body is provided with an adjustment fixing mechanism which is capable of suitably changing an arrangement distance between the at least a pair of pressing rollers in a short-side direction of the rail cover.

4. The attachment assisting jig for a rail cover according to claim 2, wherein the guide member is at least a pair of guide rollers arranged on the bottom surface of the jig main body so that peripheral surfaces of the pair of guide rollers are brought into abutment against the inner side surfaces of the pair of side wall portions, respectively, and are rotated in directions opposite to each other, and
wherein an arrangement distance between the at least a pair of pressing rollers is larger than a distance between the pair of guide rollers.
